(19) United States
(12) Patent Application Publication
(10) Pub. No.: US 2024/0199103 A1
(43) Pub. Date: Jun. 20, 2024

(54) HANDLE ASSEMBLY FOR TRANSPORTING A STRUCTURE, DOLLY INCLUDING THE SAME, AND ASSOCIATED ASSEMBLY METHOD

(71) Applicant: Rheem Manufacturing Company, Atlanta, GA (US)

(72) Inventors: Derek Ryan Bindbeutel, Atlanta, GA (US); Christopher Mark Hayden, Shelton, CT (US); Anthony Hurgoi, Algonquin, IL (US); Harsha Satyanarayana, Norwalk, CT (US); Thanh Hoang Dao, West Hartford, CT (US)

(21) Appl. No.: 18/544,034

(22) Filed: Dec. 18, 2023

Related U.S. Application Data
(60) Provisional application No. 63/387,985, filed on Dec. 19, 2022.

(51) Int. Cl. B62B 1/14; B66F 19/00

(52) U.S. Cl. CPC B62B 1/14; B66F 19/00; B62B 2203/44; B62B 2301/05

(57) ABSTRACT

A handle assembly is for transporting a structure. The handle assembly includes a retention member configured to be secured to the structure, a coupling apparatus coupled to the retention member and configured to couple the retention member to the structure, and a handle coupled to the retention member and configured to allow the structure to be transported when the retention member is coupled to the structure.

### CROSS-REFERENCE TO RELATED APPLICATIONS

This application claims priority to and the benefit of U.S. application No. 63/387,985, filed Dec. 19, 2022, which is hereby incorporated by reference in its entirety.

### FIELD

The disclosure is directed to water heater tanks and more specifically to systems and methods for transporting water heater tanks.

### BACKGROUND

Oftentimes when water heater tanks are installed in residences or other places, manipulating and maneuvering the water heater tanks can be cumbersome. For example, it is common for some water heater tanks to be cylindrically shaped and weigh around 150 pounds or more when empty. This may present a challenge to installers, who must manipulate the tanks in order to position them in the desired location and orientation. Specifically, installers may have to transport the tanks up and down stairs, in narrow or hard to reach areas of homes and buildings (e.g., utility closets, garages) and across surfaces during installation.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 shows a front perspective view of a pair of handle assemblies coupled to a structure in accordance with one or more embodiments of the present disclosure.

FIG. 2 shows a front perspective view of one of the handle assemblies of FIG. 1 in accordance with one or more embodiments of the present disclosure.

FIG. 3A shows an enlarged view of a portion of one of the handle assemblies of FIG. 1 and is shown with a coupling apparatus in a closed position in accordance with one or more embodiments of the present disclosure.

FIG. 3B shows the enlarged view of FIG. 3A with the coupling apparatus moved to an open position in accordance with one or more embodiments of the present disclosure.

FIG. 4A shows an enlarged view of another portion of one of the handle assemblies of FIG. 1 in accordance with one or more embodiments of the present disclosure.

FIGS. 4B and 4C show rear perspective views of the portion of FIG. 4A and are shown with a retention member in a first position and a second position, respectively, in accordance with one or more embodiments of the present disclosure.

FIG. 5 shows a rear perspective view of a dolly and a pair of handle assemblies coupled to a structure in accordance with one or more embodiments of the present disclosure.

FIG. 6 shows a front perspective view of the dolly and handle assemblies of FIG. 5 in accordance with one or more embodiments of the present disclosure.

FIG. 7 shows a rear perspective view of the handle assemblies of FIG. 5 coupled to the structure in accordance with one or more embodiments of the present disclosure.

FIG. 8 shows a front perspective view of the dolly of FIG. 6 without the handle assemblies in accordance with one or more embodiments of the present disclosure.

FIG. 9 shows a front perspective view of a base assembly for the dolly of FIG. 8 with one of the pins in a first position and another one of the pins in a second position in accordance with one or more embodiments of the present disclosure.

FIG. 10 shows a rear perspective view of a portion of the base assembly of FIG. 9 in accordance with one or more embodiments of the present disclosure.

FIG. 11 shows a disassembled view of the dolly and handle assemblies of FIG. 6 in accordance with one or more embodiments of the present disclosure.

FIG. 12 shows the dolly and handle assemblies of FIG. 5 coupled to another structure in accordance with one or more embodiments of the present disclosure.

FIG. 13 shows a use case for the dolly and handle assemblies of FIG. 6 in accordance with one or more embodiments of the present disclosure.

FIG. 14 shows a containment bag in accordance with one or more embodiments of the present disclosure.

FIG. 15 shows a rotated configuration of the handle assembly of FIG. 1 in accordance with one or more embodiments of the present disclosure.

FIG. 16 shows a locking mechanism for the handle assembly of FIG. 1 in accordance with one or more embodiments of the present disclosure.

### DETAILED DESCRIPTION

The systems and methods disclosed herein may assist at least in part in transporting heavy, oversized, or otherwise difficult to transport structures, such as water heater tanks. In one example, a handle assembly is provided. The handle assembly may include a retention member that can be secured around or otherwise made to securely surround the structure. A handle may be coupled to the retention member. In some instances, the retention member may be made of a metallic material, such as stainless steel or the like. In other instances, the retention member may be made of a fabric material, a polymeric material, or the like. The handle may include an ergonomic geometry that allows it to be coupled to the retention member and gripped in a manner that easily allows personnel to manipulate the structure. Any number of handle assemblies having any number of handles may be coupled to a water heater tank to transport the water heater tank by one or more people.

The handle may include an engagement portion (e.g., configured to engage the structure) that has a groove extending from one end to an opposing end, and the retention member may be located in the groove. Supports of the handle, which extend from the engagement portion to a gripping portion (e.g., for a user gripping the handle), may have slots, and the retention member may extend through the slots. As a result, the retention member is able to be securely coupled to the handle.

The handle assembly may also have a coupling apparatus and an adjustment mechanism. The coupling apparatus may be in the form of a quick release opener having a lever. The lever may move between positions in order to couple and de-couple the handle assembly to and from the structure. The adjustment mechanism may be in the form of a clamp that allows the length of the retention member which engages the structure to be adjusted, thereby allowing different diameter water heater tanks to be transported with one single handle assembly.

In another example, a dolly includes a number of handle assemblies, another retention member (e.g., one similarly constructed as those that form part of the handle assemblies), and a base assembly having a number of wheels. The retention members of the dolly may be made of similar materials described with respect to the retention members above and may be coupled to handles and a base member of the base assembly. The dolly is easy to take apart and store, thus providing a durable apparatus that can be used in transporting the structure, and also one that can be stored and stowed in a compact and unobtrusive manner. Furthermore, because the retention members of the dolly may be made of flexible materials, structures having other shapes than that of a water heater tank may be transported with the dolly.

As used herein, the phrases “any number,” “a number of,” and the like shall mean one or an integer greater than one (i.e., a plurality).

As used herein, the term “coupled” shall mean connected either directly or through one or more intermediate parts or components.

As used herein, the term “flexible” shall mean a material that is configured to conform to a profile of a solid structure. Examples of flexible materials include natural or synthetic fabric or similar materials (e.g., nylon, hemp, polypropylene, polyester, polyethylene, aramid, acrylic).

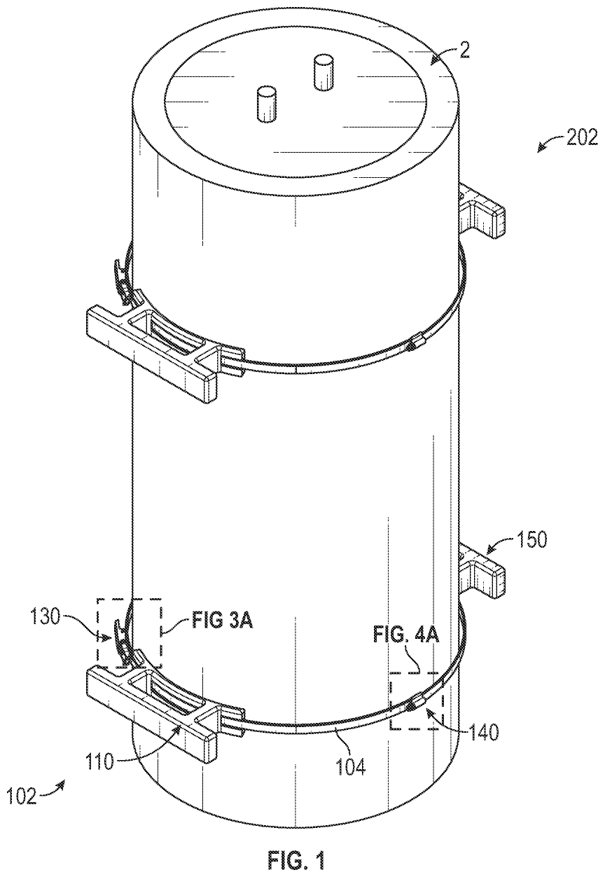

Turning now to the drawings, FIG. 1 shows a perspective view of a structure (e.g., without limitation, a water heater tank 2) and a number of handle assemblies 102,202 coupled to the water heater tank 2 and being employed for use in transporting the water heater tank 2. For case of illustration and economy of disclosure, only the handle assembly 102 will be described herein, although it will be appreciated that the handle assemblies 102,202 may have a similar structure. Additionally, while the two handle assemblies 102,202 are shown as employed for transporting the water heater tank 2, any suitable alternative number (e.g., one, three, four, etc.) of handle assemblies may be employed to transport the water heater tank 2, without departing from the scope of the disclosure.

The handle assembly 102 may include a retention member 104 configured to be secured around or otherwise securely surround the water heater tank 2, a coupling apparatus (e.g., quick release opener 130) coupled to the retention member 104 and configured to couple the retention member 104 to the water heater tank 2, and at least one handle 110,150. The handles 110,150 are configured to be coupled to the retention member 104 and are configured to allow the water heater tank 2 to be transported when the retention member 104 is coupled to the water heater tank 2. The handle 150 is structured the same as the handle 110 and is configured to be coupled to the retention member 104 in the same manner as the handle 110. The handles 110,150 may be made of a suitable material, including a monomeric material, a polymeric material, a metal or alloy material, wooden materials, or a mixture thereof.

The retention member 104 may be in the form of a band, strap, belt, or the like and may be made of metal (e.g., stainless steel) or a fabric. Additionally, the retention member 104 may have a protective coating on it (partial or full) in order to minimize scraping with the heater tank 2 when in use. The retention member 104 may also include a coating (e.g., an inner surface being made of, for example and with limitation, rubber). The handle assembly 102 advantageously assists with transporting the water heater tank 2. More specifically, in some instances, the water heater tank 2 may weigh around 150 pounds and may otherwise be difficult to transport during installation, removal, and when maintenance is being performed thereon. By employing the handle assembly 102, personnel are able to manipulate the water heater tank 2 in a relatively simple manner, as compared to typical methods which might involve personnel directly gripping the water heater tank 2. Further yet, once the water heater tank 2 is properly in position, the handle assembly 102 may easily be removed.

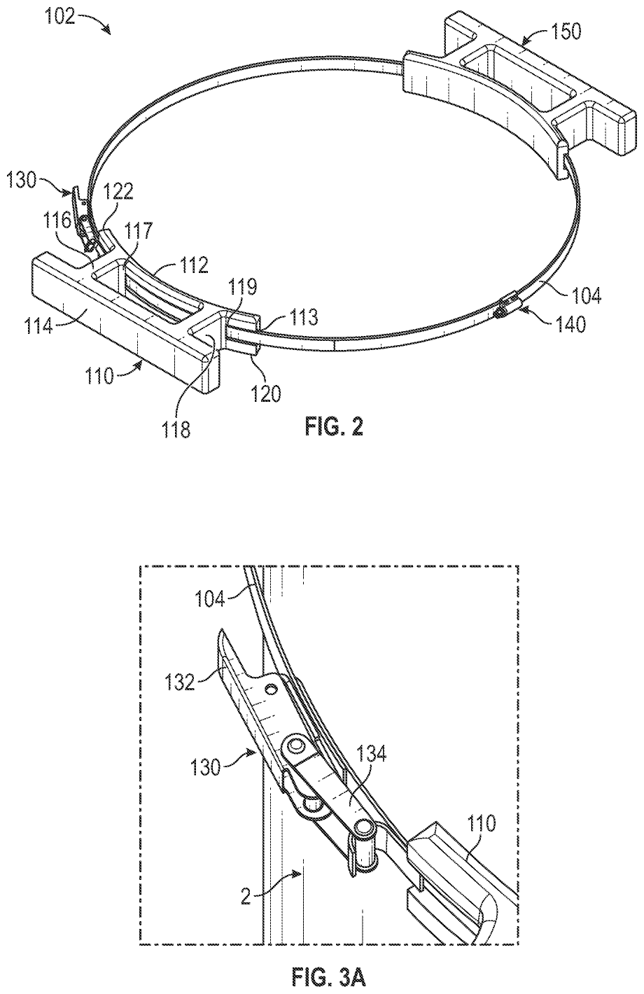

As shown in FIG. 2, the handle 110 of the handle assembly 102 has an engagement portion 112 that is configured to engage the water heater tank 2 (FIG. 1) and a gripping portion 114 spaced from the engagement portion 112 and configured to be gripped by a user when the water heater tank 2 (FIG. 1) is being transported. In one embodiment, the engagement portion 112 is concave facing away from the gripping portion 114. The engagement 112 portion may, in one example embodiment, have a radius of curvature between 10 and 40 degrees. Additionally, the gripping portion 114 may be rectangular-shaped and have a length that is between 10 and 15 times a height and 6 to 9 times a width. This may aide the handle assembly 102 in transporting cylindrical-shaped structures, such as the water heater tank 2. That is, the engagement portion 112 may engage the cylindrical surface of the water heater tank 2 in a flush manner wherein maximum surface area is contacted. However, other suitable alternative geometries for handles are contemplated herein, such as having a flat interior surface for gripping a rectangular-shaped structure. Additionally, the engagement portion 112 may have a protective coating disposed thereon (e.g., an inner layer made of a soft material, e.g., without limitation, rubber) in order to avoid scraping with the water heater tank 2.

The engagement portion 112 also may have a groove 113 extending from a first end 120 of the engagement portion 112 to a second end 122 of the engagement portion 112. The groove 113 may be an indented portion of the engagement portion 112 that has a constant cross-sectional-profile from the first to second end 120,122, and configured to constantly receive the retention member 104. The first end 120 is located opposite the second end 122, and the retention member 104 is located in the groove 113. As such, from the first end 120 to the second end 122, the retention member 104 is maintained on the handle 110. Thus, the likelihood of there being undesirable slipping of the retention member 104 with respect to the handle 110 is minimized.

Continuing to refer to FIG. 2, the handle 110 further may include a number of supports 116,118 extending from the engagement portion 112 to the gripping portion 114, with each being substantially transverse or perpendicular to (e.g., at an angle between 85 and 95 degrees with respect to) the engagement portion 112 and the gripping portion 114. In the example of FIG. 2, the first support 116 is spaced from the second support 118. As shown, the supports 116,118 each have a corresponding slot 117,119, and the retention member 104 extends through the slots 117,119. In this manner, the retention member 104 is able to be coupled to the handle 110.

Additionally, as the gripping portion 114 is spaced from the engagement portion 112, and supported by the supports 116,118, personnel will have a reliable structure on which to grip when transporting the water heater tank 2. That is, personnel may grip between the supports 116,118, or on an opposite side of the supports 116,118, when grasping the handle 110.

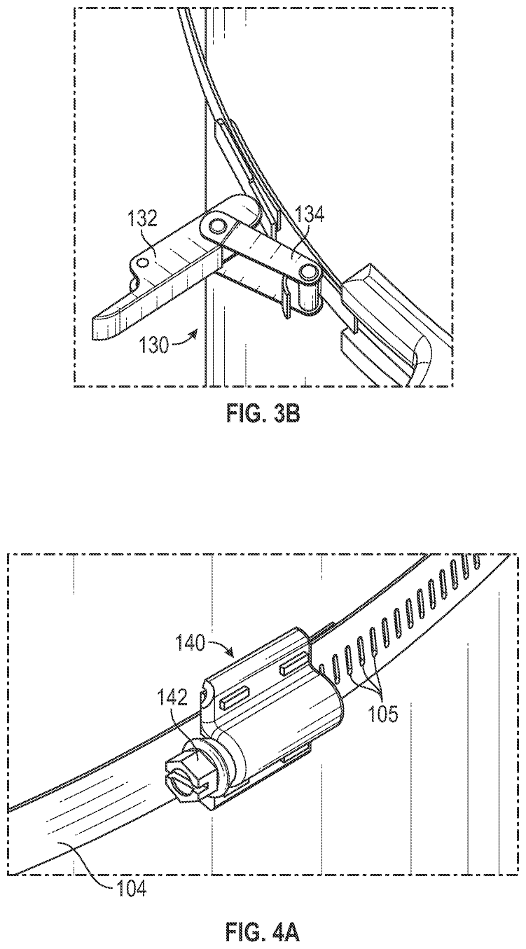

In order to couple and de-couple the handle assembly 102 to and from the water heater tank 2, the quick release opener 130 may include a lever 132 and a coupling member 134 may be coupled to the lever 132 and the retention member 104 via a hook (shown but not labeled) that is coupled to the retention member 104. As shown in FIGS. 3A and 3B, movement of the lever 132 moves the retention member 104 between a first position (FIG. 3A) corresponding to the retention member 104 having a first length engaging the heater tank 2, and a second position (FIG. 3B) corresponding to the retention member having a second length when engaging the heater tank 2. In this example, the second length may be greater than the first length. That is, when the lever 132 opens, the length of the retention member 104 increases and the coupling member 134 can be disengaged from the handle 110 to “open” the handle assembly 102. Thus, this movement allows the handle assembly 102 to be easily removed from the water heater tank 2, and also allows the handle assembly 102 to be securely coupled and tightened to the water heater tank 2 (e.g., when the lever 132 moves from the position depicted in FIG. 3B to the position depicted in FIG. 3A). In embodiments, any other suitable mechanism may be used to allow the handle assembly 102 to be securely coupled and tightened to the water heater tank 2, such as a ratchet, for example.

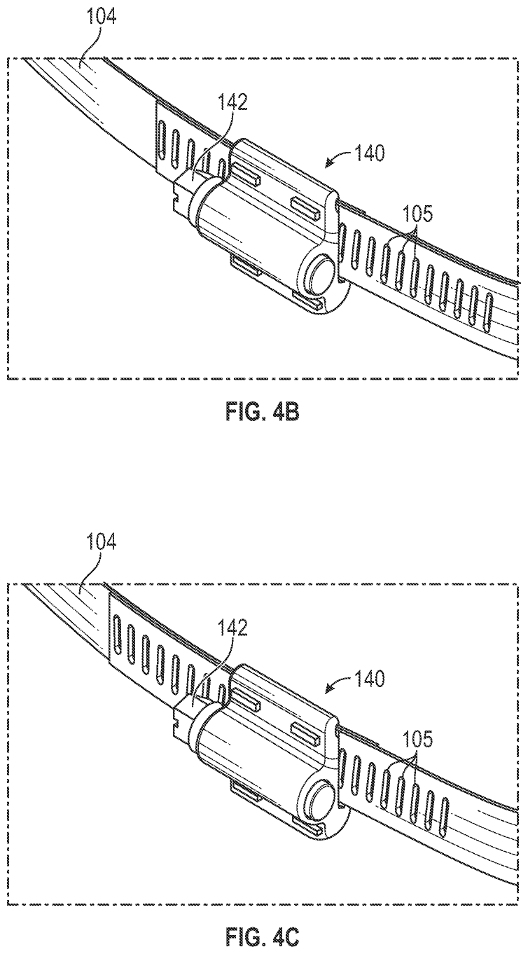

In one example embodiment, as shown in FIG. 4A, the handle assembly 102 also includes an adjustment mechanism (e.g., clamp 140) that is coupled to the retention member 104 and spaced from the quick release opener 130. The clamp 140 is configured to move the retention member 104 between a first position (FIG. 4B) corresponding to the retention member 104 having a first length which engages the heater tank 2, and a second position (FIG. 4C) corresponding to the retention member having a second length which engages the heater tank 2. It will be appreciated when viewing FIGS. 4B and 4C that in the second position (FIG. 4C), the second length is less than the first length. Accordingly, the clamp 140 allows the handle assembly 102 to be employed with water heater tanks that have different diameters.

Additionally, while the coupling apparatus 130 allows the length of the retention member 104 to be adjusted relatively easily via movement of the lever 132, the adjustment mechanism allows the length to be changed in a more fixed manner such that different diameter tanks would have the length of the retention member 104 changed for each of them, while for a given tank, the coupling apparatus 130 would allow the length to be changed.

Continuing to refer to FIGS. 4B and 4C, the retention member 104 may include a plurality of slots (e.g., thru holes 105), and the clamp 140 may have a tongue. The tongue of the clamp 140 is configured to extend through any of the thru holes 105 in order to move the retention member from the first position (FIG. 4B) toward the second position (FIG. 4C), and toward other positions wherein the retention member 104 would have different lengths. More specifically, if a user rotates a drive member 142 of the clamp, the tongue of the clamp 140 may move into or out of engagement with one of the slots 105. That is, movement of the clamp 140 in turn drives the tongue of the mechanism up and down, with respect to the slots 105, thereby allowing the length of the retention member 104 to be changed. In turn, this allows for adjustment of the length of the retention member 104 which engages the heater tank 2 in a simple and reliable manner.

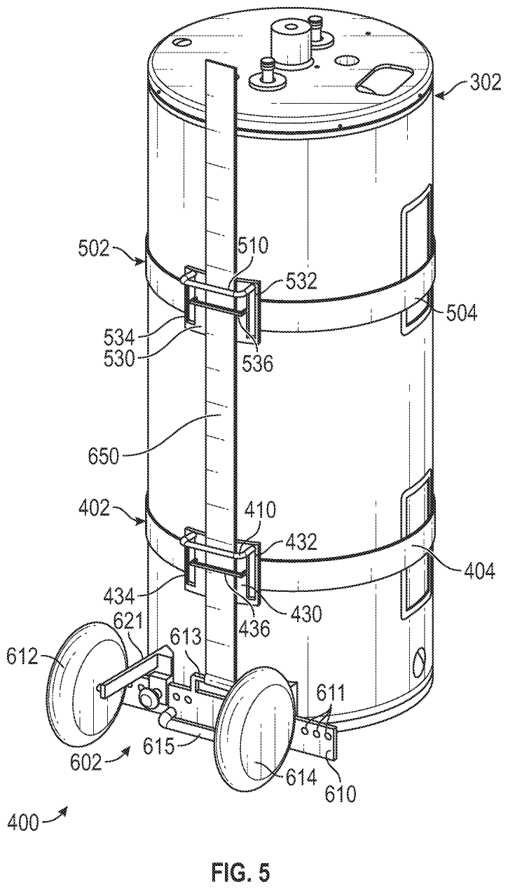

In another example embodiment, FIG. 5 shows a perspective view of a dolly 400 employing a number of handle assemblies 402,502. The dolly 400 is depicted coupled to a structure (e.g., water heater tank 302). The dolly 400 may be used by coupling the water heater tank 302 to the handle assemblies (e.g., different than conventional dollies in which structures are simply maintained on the dolly) pivoting the water heater tank 302, and wheeling the water heater tank 302, as will be discussed below.

The handle assemblies 402,502 have similar components as the handle assemblies 102,202, discussed above, and like numbers represent like features. In one embodiment, the retention members 404,504 of the handle assemblies 402,502 are each made of a flexible material, and are thus able to be easily coupled to and removed from the coupling apparatuses 430,530. Thus, the retention members 404,504 are removably coupled to the coupling apparatuses 430,530. Additionally, while the retention members 404,504 are advantageously able to couple the dolly 400 to the water heater tank 302, the flexible nature of the retention members 404,504 makes them easy to transport and store, as will be discussed below. Furthermore, by surrounding the water heater tank 302, the retention members 404,504 are able to maintain the water heater tank 302 in a more secure manner than typical dollies, which typically do not provide for mechanisms to couple the structures to the dollies.

The coupling apparatuses 430,530 and the handles 410,510 may each be formed as unitary components that are made from single pieces of material. Continuing to refer to FIG. 5, the coupling apparatuses 430,530 may each have corresponding slots 432,434,532,534 and the retention members 404,504 may be configured to extend through the slots 432,434,532,534 in order for the retention members 404,504 to be coupled to the handles 410,510.

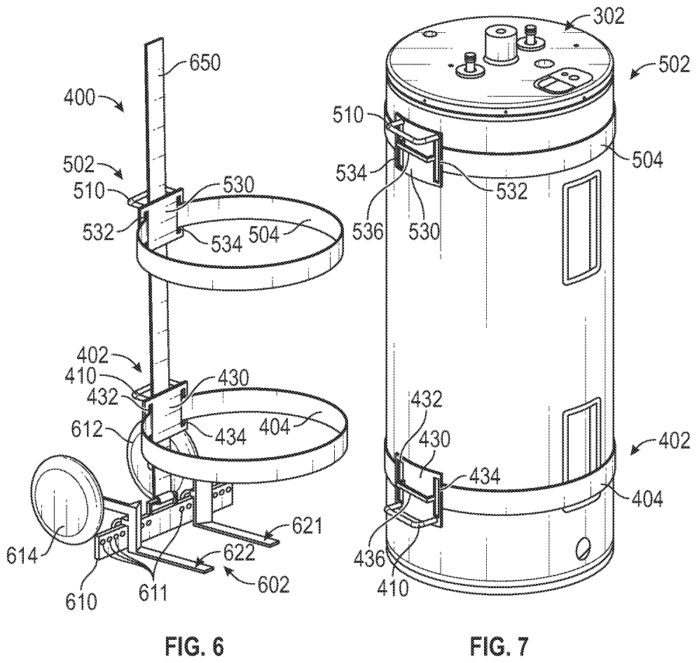

FIG. 6 shows a view of the dolly 400. As shown, in addition to the handle assemblies 402,502, the dolly 400 further includes a base assembly 602 and another retention member 650. The other retention member 650, as shown in FIG. 5, is coupled to the handles 410,510 via gripping members 436,536 formed as part of the handles 410,510 and the coupling apparatuses 430,530. When the retention members 404,504 are coupled to the water heater tank 302, the retention members 404,504 are configured to be oriented perpendicularly to the other retention member 650. Additionally, the other retention member 650 may also, like the retention members 404,504, be made of a flexible material, thereby providing advantages in terms of breakdown and storage of the dolly 400. It will be appreciated that the FIGS. show the additional retention member 650 in simplified form for purposes of illustration. However, in practice the flexible nature of the additional retention member 650 makes it conducive for storage and transport, in addition to use with the dolly 400.

FIG. 7 shows the handle assemblies 402,502 coupled to the water heater tank 302. It will be appreciated that a first step of using the dolly 400 may include securing the retention members 404,504 around the water heater tank 302. Next, the retention members 404,504 may be coupled to the corresponding coupling apparatuses 430,530 by extending the retention members through the slots 432,434,532,534 and tightening the retention members 404,504 (e.g., in substantially the same manner in which straps on a book bag tighten through a clasp to allow the bookbag to properly secure to a person). Alternatively, the retention members 404,504 may be coupled to the coupling apparatuses 430,530 (e.g., and thus the handles 410,510), and then the retention members 404,504 may be secured around the water heater tank 302. Subsequently, as will be discussed below, the base assembly 602 and the other retention member 650 may be coupled to the handle assemblies 402,502.

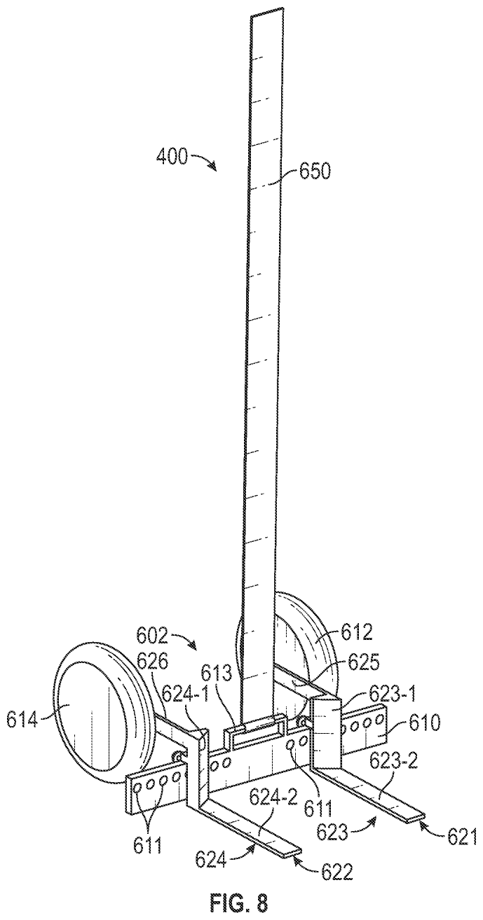

FIG. 8 shows a perspective view of the dolly 400 and is shown without the handle assemblies 402,502. As shown, the base assembly 602 includes a base member 610 and a number of wheels 612,614 coupled to the base member 610. The wheels 612,614 allow the water heater tank 302 to be wheeled about a surface, and the base member 610 allows the retention members 404,504,650 to be usable with the dolly 400 (e.g., via a connection with the additional retention member 650). Additionally, as shown, the base member 610 has a body and an optional handle 613 extending outwardly from the body, which is coupled to the other retention member 650. The handle 613 may be located midway between the wheels 612,614 in order to reliably maintain the other retention member 650 in a stable position.

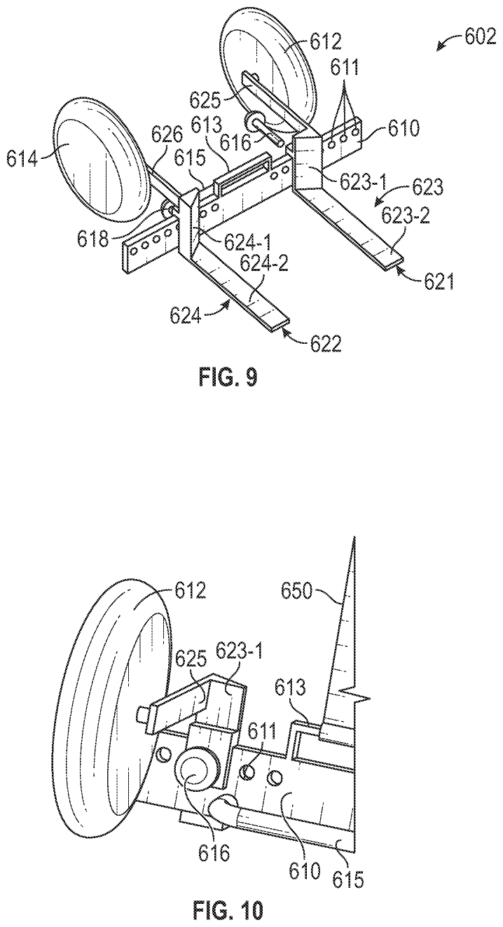

FIG. 9 shows a front perspective view of the base assembly 602, and FIG. 10 shows a rear perspective view of a portion of the base assembly 602. As shown in FIG. 9, the base assembly 602 includes the first and second wheels 612,614 as well as corresponding first and second support members 621,622 coupled to the wheels 612,614. The support members 621,622 function to couple the wheels 612,614 to the base member 610, and also to give structural support to the dolly 400 when in use.

The first and second support members 621,622 each include L-shaped legs 623,624 and corresponding elongated elements 625,626 that couple the L-shaped legs 623,624 to the wheels 612,614. The example L-shaped legs 623,624 include first legs 623-1,624-1 and second legs 623-2,624-2 oriented perpendicular to the first legs 623-1,624-1. Additionally, the first legs 623-1, 624-1 connect the elements 625,626 to the second legs 623-2,624-2. In this manner, the support members 621,622 advantageously provide a reliable structure on which the water heater tank 302 (FIG. 5) can be located. Furthermore, in one example the first legs 623-1,624-1 have surfaces that are oriented at obtuse angles with respect to the base member 610, thus providing for an ergonomic structure for the cylindrical-shaped geometry of the water heater tank 302 (FIG. 5) to engage. The surfaces of the first legs 623-1,624-1 might also be concave corresponding to a surface of a heater tank. The first and second support members 621,622 may also be structured as mirror images of each other.

Continuing to refer to FIG. 9, the base member 610 optionally has a plurality of thru holes 611, and the base assembly 602 further has a first and second pins 616,618 (e.g., retention pins that are spring loaded (e.g., detents) that are each removably coupled to a corresponding one of the first and second support members 621,622 and are configured to be moved between a first position and a second position. See, for example, pin 616 in exploded form in a first position not extending through any of the plurality of thru holes 611. Correspondingly, it will be appreciated that pin 618 is in a second position extending through one of the thru holes 611 in order to couple the second support member 622 to the base member 610. In operation, both pins 616,618 extend through a thru hole in order to couple the support members 621,622 to the base member 610. However, both of the pins 616,618 are movable from first to any number of second positions. Any number of pins may be used herein. The pins may be located in any of the thru holes 611. The pins 616,618 may be biased by biasing elements (e.g., spring loaded detents), which may maintain the pins through one of the thru holes 611.

FIG. 11 shows an example arrangement of the dolly 400 that may be suitable for storage. As shown, the dolly 400 can be contained in a relatively compact space, as compared to typical dollies, which typically have components that are welded together, and which cannot be broken down and stowed. The retention members 404,504,650 are advantageously able to be wound up into a compact space, and the other components of the dolly similarly are able to be disassembled and stored in a simple manner.

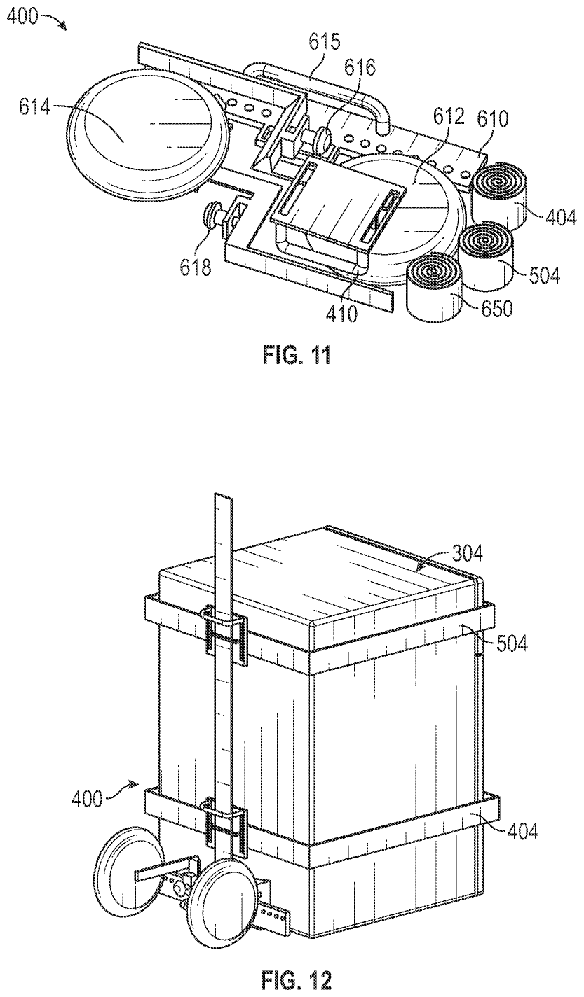

FIG. 12 shows another use case for the dolly 400. As shown, the retention members 404,504 are secured around another structure (e.g., refrigerator 304). Accordingly, the dolly 400 may be employed to transport any number of structures, including, for example the cylindrical-shaped water heater tank 302 and the rectangular-shaped refrigerator 304. In some instances, the water heater tank may also be rectangular-shaped.

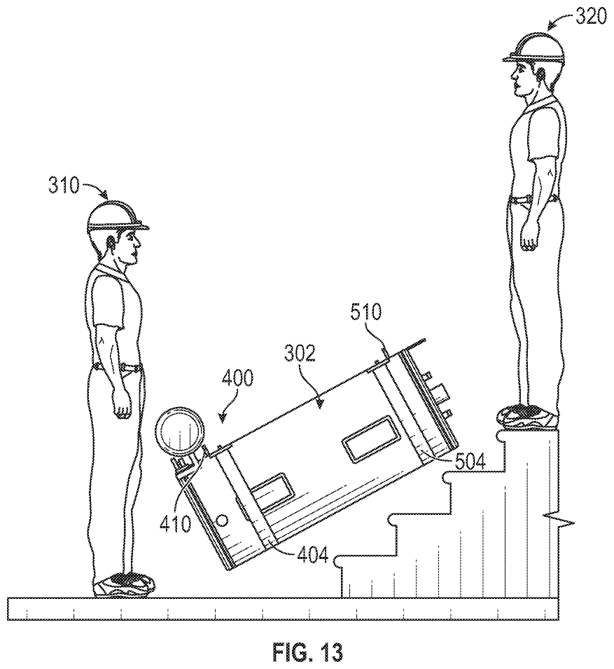

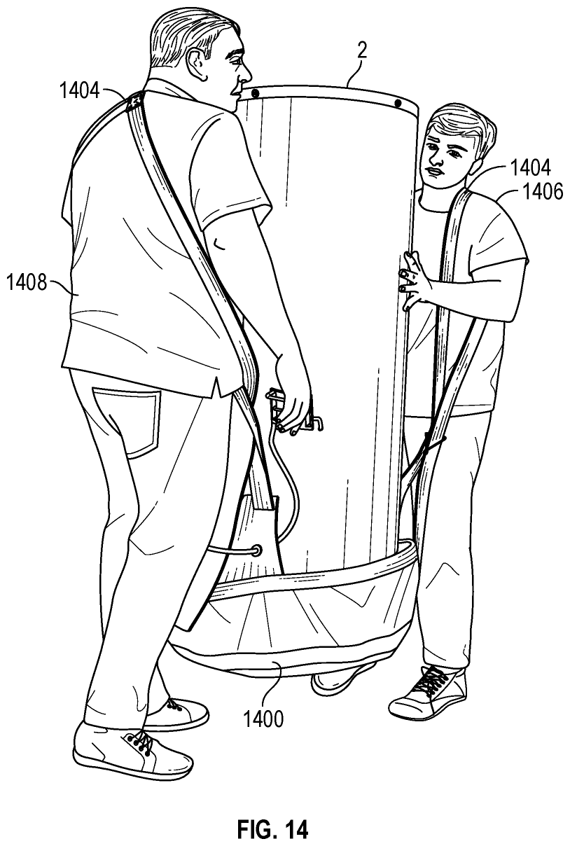

FIG. 13 shows the dolly 400 being employed by two individuals 310,320 to transport the water heater tank 302 up or down a flight of stairs. It will be appreciated that the dolly 400 provides a convenient method of transporting the water heater tank 302, whereby the individuals 310,320 may need to only grasp the handles 410,510 and lift the water heater tank 302. This is desirable, as compared to typical methods of transporting the heater tank 302.

Accordingly, it will be appreciated that an assembly method for use with transporting a structure 2,302,304 includes the steps of providing a handle assembly 102,202,402,502 with a retention member 104,404,504, a coupling apparatus 130,430,530 coupled to the retention member 104,404,504, and a handle 110,150,410,510 coupled to the retention member 104,404,504, securing the retention member 104,404,504 around the structure, employing the coupling apparatus 130,430,530 in order to couple the retention member 104,404,504 to the structure 2,302,304, and gripping the handle 110,150,410,510 in order to transport the structure 2,302,304. Employing the coupling apparatus 130 may further include moving the lever 132 in order to move the retention member 104 between a first position corresponding to the retention member 104 having a first length when engaging the heater tank 2, and a second position corresponding to the retention member 104 having a second length when engaging the heater tank 2, the second length being less than the first length. Providing the handle assembly 102,202 may further include extending the retention member 104 through the slots 117,119 of the supports 116,118, and disposing the retention member 104 in the groove 113 of the engagement portion 112.

In another example embodiment, the method may further include providing the retention member 650 coupled to the handle 410,510, providing the base assembly 602 including a base member 610, a first support member 621 coupled to the base member 610, a first wheel 612 coupled to the first support member 621, a second support member 622 coupled to the base member 610, and a second wheel 614 coupled to the second support member 622, coupling the base member 610 to the second retention member 650, and making the retention members 404,504,650 out of fabric materials.

Accordingly, it will be appreciated that the disclosed systems and methods provide for an improved (e.g., without limitation, better able to transport structures, easier to store) handle assembly 102,202,402,502, dolly 400, and associated method, in which a retention member 104,404,504 is configured to be secured around the structure 2,302,304, and a handle 110,150,410,510 is coupled to the retention member 104,404,504 in order to allow the structure to be transported.

FIG. 14 shows a containment bag 1400 that may serve as an alternative mechanism by which one or more users (for example, user 1406 and user 1408) may transport a water heater tank 2 (although reference is made to a water heater tank 2, the containment bag 1400 may be used to transport any other type of structure as well), The containment bag 1400 may also be used in combination with other mechanisms used to transport the water heater tank 2 described herein, such as the handle assembly 102 (or any other handle assembly), as one non-limiting example. The water heater tank 2 may be provided within the containment bag 1400 to provide for transport of the water heater tank 2. Although FIG. 14 only shows the containment bag 1400 as encompassing a portion of the water heater tank 2 (for example, at the bottom of the water heater tank 2), however, the containment bag 1400 may be any other suitable size and/or shape such that the containment bag 1400 may encompass any other amount of the water heater tank 2 when the water heater tank is provided in the containment bag 1400. Further, in some instances, the water heater tank 2 may be provided within the containment bag 1400 prior to arrival at an installation location (for example, residential home, commercial building, etc.). In this manner, a user may not need to maneuver the water heater tank 2 on the ground at the installation location to place the water heater tank 2 within the containment bag 1400.

The containment bag 1400 may be made from any suitable material. As one example, the containment bag 1400 may be made from a flexible material, such as a canvas material (or any other type of flexible material). Using a containment bag 1400 made form a flexible material may allow for the containment bag 1400 to more easily receive various sizes and/or shapes of water heater tanks 2. As another example, the containment bag 1400 may be made from a rigid material, such as a plastic or a metal. In such instances, the containment bag 1400 may be sizes and/or shaped to receive specific types of structures, such as the water heater tank 2. However, any other type of material may be used for the containment bag 1400 as well.

Affixed to the containment bag 1400 may be one or more straps 1404. The one or more straps 1404 may be used by the one or more users to lift the containment bag 1400 with the water heater tank 2 inside the containment bag 1400 for transport of the water heater tank 2. In some instances, the one or more straps may be provided around the shoulders and/or back of the users and may reduce the amount of pressure on the lower back of the users as they lift and transport the water heater tank 2 using the containment bag 1400. However, the one or more straps 1404 may be provided around any other portions of the body as well. Additionally, although the figure shows two sets of straps 1404 being used by two users, this is merely exemplary and any other number of straps may be affixed to the containment bag 1400. Further, in some embodiments, the one or more straps 1404 may be removably affixed to the containment bag 1400 such that the one or more straps 1404 may be affixed to and/or removed from the containment bag 1400 as desired.

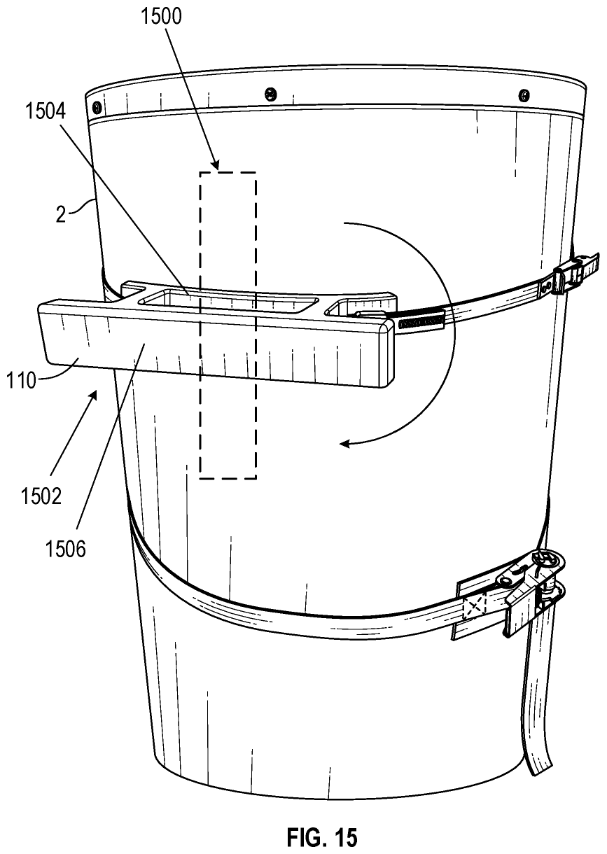

FIG. 15 shows a rotated configuration of the handle assembly 102 of FIG. 1 in accordance with one or more embodiments of the present disclosure. Particularly, FIG. 15 shows that the handle 110 (or any other handle described herein) may not necessarily be fixed, but rather may be rotated to different orientations depending on the preferences of the user that is transporting the water heater tank 2 (or other structure). Particularly, the figure shows the handle 110 being rotated from a first orientation 1500 (e.g., vertical orientation) to a second orientation 1502 (e.g., horizontal orientation). The handle 110 may also be rotated by any other amount as well (e.g., 10 degrees, 20 degrees, 30 degrees, etc.).

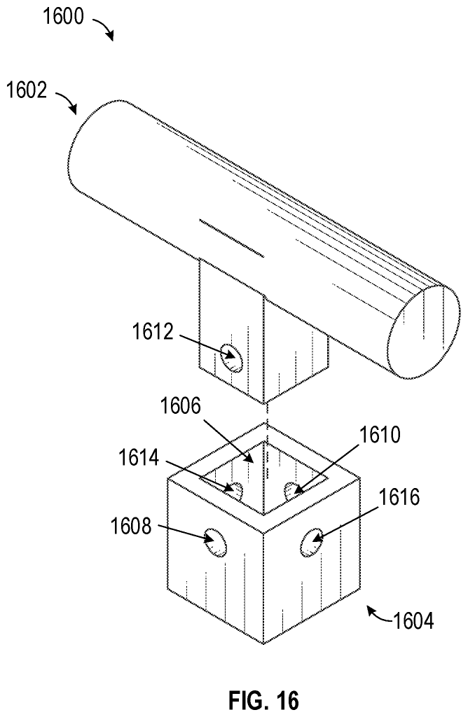

FIG. 16 shows a locking mechanism 1600 for the handle assembly 102 of FIG. 1. Particularly, FIG. 16 shows the mechanism by which the rotation of the handle 110 shown in FIG. 15 may be performed (or any other handle described herein). The locking mechanism 1600 may include two portions (a first portion 1602 and a second portion 1604). In embodiments, the first portion 1602 of the locking mechanism 1600 may be affixed to a first portion 1504 of the handle 110 and the second portion 1604 of the locking mechanism 1600 may be affixed to a second portion 1506 of the handle 110. However, this is not limiting and the first portion 1602 of the locking mechanism 1600 may be affixed to the second portion 1506 of the handle 110 and the second portion 1604 of the locking mechanism 1600 may be affixed to the first portion 1504 of the handle 110. The first portion 1602 of the locking mechanism 1600 and the second portion of the locking mechanism 1600 may also be integrated into the handle 110 (or any other handle), rather than being separate components that are affixed to the handle 110.

To lock the handle 110 in a particular orientation, the first portion 1602 of the locking mechanism 1600 may be inserted into the second portion 1604 of the locking mechanism 1600 via a first aperture 1606 provided at the second portion 1604 of the locking mechanism 1600. Once the first portion 1602 of the locking mechanism 1604 is provided within the second portion 1604 of the locking mechanism, the first portion 1602 and second portion 1604 may be secured together by inserting a pin (not shown) through additional apertures on the first portion 1602 and the second portion 1604. For example, in one orientation, the second aperture 1608 and third aperture 1610 on the second portion 1604 and fourth aperture 1612 and fifth aperture (not shown) of the first portion 1602 may be aligned and a pin may be inserted through these apertures to secure the first portion 1602 to the second portion 1604. In another orientation, the seventh aperture 1614 and eighth aperture 1616 on the second portion 1604 and fourth aperture 1612 and fifth aperture (not shown) of the first portion 1602 may be aligned and a pin may be inserted through these apertures to secure the first portion 1602 to the second portion 1604.

The configuration of the first portion 1602 and the second portion 1604 are merely exemplary and any other configurations may also be possible. That is, the first portion 1602 and the second portion 1604 may be provided in any other suitable combination of sizes and/or shapes. As one example, the second portion 1604 may be a cylindrical shape such that additional apertures may be provided to allow for more granular degrees of rotation of the handle 110 (in contrast with the two orientations at 90 degrees relative to one another as shown in FIG. 15). Additionally, the first portion 1602 and the second portion 1604 may be locked together or unlocked using an element other than a pin, such as a bolt, etc. Finally, the locking mechanism 1600 shown in FIG. 16 is merely exemplary and any other type of mechanism may be used to facilitate the rotation of the handle 110 shown in FIG. 15 (or any other handle) to different orientations.

It should be apparent that the foregoing relates only to certain embodiments of the present application and that numerous changes and modifications may be made herein by one of ordinary skill in the art without departing from the general spirit and scope of the disclosure.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A handle assembly for transporting a structure, the handle assembly comprising:
a retention member configured to be secured around the structure;
a coupling apparatus coupled to the retention member and configured to couple the retention member to the structure; and
a handle configured to be coupled to the retention member to allow the structure to be transported via the handle when the retention member is coupled to the structure.

2. The handle assembly according to claim 1, wherein the handle comprises an engagement portion and a gripping portion, wherein the engagement portion is configured to engage a surface of the structure, and wherein the gripping portion is spaced from the engagement portion and configured to be gripped by a user when the structure is being transported.

3. The handle assembly according to claim 2, wherein the engagement portion is concave facing away from the gripping portion.

4. The handle assembly according to claim 2, wherein the handle comprises at least one support extending from the engagement portion to the gripping portion, wherein the at least one support has a slot, and wherein the retention member extends through the slot.

5. The handle assembly according to claim 4, wherein the coupling apparatus is a quick release opener having a lever, wherein movement of the lever is configured to move the retention member between a first position corresponding to the retention member having a first length and a second position corresponding to the retention member having a second length, and wherein the second length is greater than the first length.

6. The handle assembly according to claim 4, further comprising an adjustment mechanism coupled to the retention member and spaced from the coupling apparatus, wherein the adjustment mechanism is configured to move the retention member between a first position corresponding to the retention member having a first length and a second position corresponding to the retention member having a second length, and wherein the second length is greater than the first length.

7. The handle assembly according to claim 6, wherein the retention member has a plurality of slots, and wherein the adjustment mechanism comprises a tongue configured to extend through each of the plurality of slots in order to move the retention member from the first position toward the second position.

8. The handle assembly according to claim 4, wherein the at least one support comprises a first support and a second support spaced from the first support, and wherein the retention member extends through the slot of the first support and the slot of the second support.

9. The handle assembly according to claim 8, wherein the engagement portion has a groove extending from a first end of the engagement portion to a second end of the engagement portion, wherein the first end is located opposite the second end, and wherein the retention member is disposed in the groove of the engagement portion.

10. The handle assembly according to claim 4, wherein the at least one support comprises a first support and a second support spaced from the first support, and wherein each of the first and second supports are substantially perpendicular to each of the engagement portion and the gripping portion.

11. The handle assembly according to claim 4, wherein the handle is a first handle, and wherein the handle assembly further comprises a second handle structured substantially the same as the first handle and coupled to the retention member in the same manner as the first handle.

12. A dolly comprising:
a handle assembly for transporting a structure, the handle assembly comprising:
a first retention member configured to be secured around the structure,
a coupling apparatus coupled to the first retention member and configured to couple the first retention member to the structure, and
a handle coupled to the first retention member and configured to allow the structure to be transported when the first retention member is coupled to the structure,
a second retention member coupled to the handle; and
a base assembly comprising a base member and a number of wheels coupled to the base member, the base member being coupled to the second retention member.

13. The dolly according to claim 12, wherein the first and second retention members are each made of a flexible material.

14. The dolly according to claim 13, wherein the number of wheels comprises a first wheel and a second wheel, and wherein the base assembly further comprises a first support member and a second support member each coupled to the base member and a corresponding one of the first and second wheels.

15. The dolly according to claim 14, wherein the base member has a plurality of thru holes, wherein the base assembly further comprises a first pin and a second pin each coupled to a corresponding one of the first and second support members and configured to move between a first position and a second position, wherein the first position corresponds to the first and second pins not extending through any of the plurality of thru holes, and wherein the second position corresponds to the first and second pins each extending through a corresponding one of the plurality of thru holes in order to couple the first and second support members to the base member.

16. The dolly according to claim 14, wherein the first support member comprises an L-shaped leg and an elongated element, wherein the element couples the L-shaped leg to the first wheel, wherein the L-shaped leg comprises a first leg and a second leg oriented perpendicular to the first leg, wherein the first leg connects the element to the second leg, wherein the first leg has a surface oriented at an obtuse angle with respect to the base member, and wherein the second support member is structured as a mirror image of the first support member.

17. The dolly according to claim 14, wherein the handle is a first handle, and wherein the base member comprises a body and a gripping member extending outwardly from the body and being disposed midway between the first wheel and the second wheel.

18. The dolly according to claim 12, wherein the coupling apparatus and the handle are formed as a unitary component made from a single piece of material.

19. The dolly according to claim 12, wherein the handle assembly is a first handle assembly, wherein the dolly further comprises a second handle assembly structured substantially the same as the first handle assembly, and wherein the second retention member is coupled to the handle of the second handle assembly.

20. The dolly according to claim 19, wherein, when the first retention members of the first and second handle assemblies are coupled to the structure, the first retention members of the first and second handle assemblies are configured to be oriented perpendicular to the second retention member.

21. A method for transporting a structure, the method comprising the steps of:
providing a handle assembly with a retention member, a coupling apparatus coupled to the retention member, and a handle coupled to the retention member;
securing the retention member around the structure;
employing the coupling apparatus in order to couple the retention member to the structure; and
gripping the handle in order to transport the structure.

22. The method according to claim 21, wherein the coupling apparatus is a quick release opener having a lever, and wherein employing the coupling apparatus further comprises:
moving the lever in order to move the retention member between a first position corresponding to the retention member having a first length, and a second position corresponding to the retention member having a second length, the second length being greater than the first length.

23. The method according to claim 22, wherein the handle comprises a gripping portion, an engagement portion spaced from the gripping portion, and at least one support extending from the engagement portion to the gripping portion, wherein the at least one support has a slot, and wherein providing the handle assembly comprises:
extending the retention member through the slot.

24. The method according to claim 23, wherein the at least one support comprises a first support and a second support spaced from the first support, wherein the engagement portion has a groove extending from a first end of the engagement portion to a second end of the engagement portion, wherein the first end is located opposite the second end, and wherein providing the handle assembly further comprises:
extending the retention member through the slot of the first support and the slot of the second support; and
disposing the retention member in the groove of the engagement portion.

25. The method according to claim 21, wherein the retention member is a first retention member, and wherein the method further comprises:
providing a second retention member coupled to the handle;
providing a base assembly comprising a base member, a first support member coupled to the base member, a first wheel coupled to the first support member, a second support member coupled to the base member, and a second wheel coupled to the second support member;
coupling the base member to the second retention member; and
making the first and second retention members out of fabric materials.
